(19) United States
(12) Patent Application Publication
(10) Pub. No.: US 2025/0072644 A1
(43) Pub. Date: Mar. 6, 2025

(54) JUICING MODULE FOR A PREPARATION VESSEL, KITCHEN APPLIANCE AND GEAR UNIT

(71) Applicant: Vorwerk & Co. Interholding GmbH, Wuppertal (DE)

(72) Inventors: Marvin Buschkühle, Düsseldorf (DE); Michael Sickert, Ennepetal (DE); Andreas Heynen, Radevormwald (DE); Ingo Ehring, Bottrop (DE)

(21) Appl. No.: 18/238,583

(22) Filed: Aug. 28, 2023

(30) Foreign Application Priority Data
Sep. 6, 2022 (EP) 22194188.3

(51) Int. Cl. A47J 19/02; A47J 43/046; A47J 43/07; A47J 43/08

(52) U.S. Cl. CPC A47J 19/025; A47J 43/046; A47J 43/0716; A47J 43/0772; A47J 43/085

(57) ABSTRACT

A juicing module for cooperating with a preparation vessel with at least one rotatable tool holder, having at least one drive interface and at least one juicer tool, wherein the juicer tool is connectable to the drive interface so that a rotation of at least a part of the juicer tool can be effected with a rotation of the drive interface. The juicer tool has at least one guide body and at least one sieve unit, in that a movement between guide body and sieve unit can be effected with a rotation of the drive interface, and in that the guide body and the sieve unit are designed/arranged such that, with a relative movement between guide body and sieve unit, a foodstuff to be juiced can be conveyed into a tapering gap between the guide body and sieve unit in order to bring about a pressing force on the foodstuff.

### CROSS REFERENCE TO RELATED APPLICATIONS

This application claims the benefit of priority under 35 U.S.C. § 119 to European Patent Application No.: 22194188.3, filed Sep. 6, 2022, the contents of which is incorporated herein by reference in its entirety.

### FIELD

The invention relates to a juicing module for cooperating with a preparation vessel having at least one rotatable tool holder. The preparation vessel is, for example, part of a kitchen appliance for preparing food. The juicing module comprises at least one drive interface and at least one juicer tool. The juicer tool is connectable or connected to the drive interface, so that a rotation of the drive interface can effect a rotation of at least a part of the juicer tool.

### BACKGROUND

The statements in this section merely provide background information related to the present disclosure and several definitions for terms used in the present disclosure and may not constitute prior art.

For many people, healthy nutrition is a central part of their daily routine. For the production of juices, a large number of aids are conventionally known with which foods, in particular fruits and vegetables, can be juiced. Hand-operated tools, such as juicing cones for citrus fruits or manual graters, e.g. for apples or vegetables, are usually used for this purpose. Furthermore, a variety of electrically operated juicing devices are known, which chop or crush the food to be juiced and substantially separate the liquid obtained from the solid components of the food.

However, the aids or devices known from the prior art have the disadvantage that either an enormous effort and time must be expended on the part of the user, or-in the case of electric centrifugal juicers-a device that can only be used for the purpose of juicing, for example as disclosed in KR 2006/0101848 A, must always be stored.

An objective of the present disclosure is therefore based on the task of providing an aid for juicing foodstuffs, the handling of which reduces the effort required by the user and, at the same time, eliminates the need for an additional device.

### SUMMARY

The objective of the present disclosure is solved in a generic juicing module for cooperating with a preparation vessel having at least one rotatable tool holder, comprising at least one drive interface and at least one juicer tool, wherein the juicer tool can be connected to the drive interface so that a rotation of at least a part of the juicer tool can be effected with a rotation of the drive interface. The juicer tool has at least one guide body and at least one sieve unit, in that a relative movement between guide body and sieve unit can be effected with a rotation of the drive interface, and in that the guide body and the sieve unit are designed and arranged in such a manner that with a relative movement between guide body and sieve unit a food to be juiced can be conveyed into a tapering gap between the guide body and the sieve unit in order to effect a pressing force on the food to be juiced.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows an embodiment of a juicing module according to the teachings of the present disclosure in at least partially cut side view;

FIG. 2 shows a further embodiment of a juicing module according to the teachings of the present disclosure in at least partially cut side view;

FIGS. 3a to 3d show a perspective and side view of an embodiment example of a sieve unit;

FIG. 4 shows a perspective view of a juicing module according to the teachings of the present disclosure;

FIG. 5a a perspective view of an example of a gear unit from the outside;

FIG. 5b shows an exploded view of the gear unit according to FIG. 5a; and

FIG. 6 shows a schematic representation of the control sequences of the control device of a kitchen appliance.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the juicing module, for cooperating with a preparation vessel having at least one rotatable tool holder, comprises at least one drive interface and at least one juicer tool, wherein the juicer tool can be connected to the drive interface so that a rotation of at least a part of the juicer tool can be effected with a rotation of the drive interface. The juicer tool has at least one guide body and at least one sieve unit. The drive interface and the juicer tool are connectable or connected in such a way that a relative movement between guide body and sieve unit can be effected with a rotation of the drive interface. The guide body and the sieve unit are designed and arranged in such a way that with this relative movement a pressing force acting between the guide body and the sieve unit on a food to be juiced can be effected, whereby liquid components are pressed out of a food to be juiced. In particular, with a relative movement between guide body and sieve unit, a food to be juiced can be conveyed into a tapering gap, preferably an annular gap, between the guide body and the sieve unit in order to effect a pressing force on the food to be juiced.

In a large number of households, kitchen appliances are already in use that have a preparation vessel with at least one rotatable tool holder. For example, these are kitchen appliances that are designed for preparing food. The preparation vessel has a volume into which the prepared food is introduced. At the bottom of the preparation vessel, the rotatable tool holder or the tool attached to the rotatable tool holder is usually arranged. When the preparation vessel is inserted into the kitchen appliance, the tool holder can be driven in rotation by a motor of the kitchen appliance, in particular at variable speeds.

The tool holder has, for example, a shaft passing through the preparation vessel. In particular, the shaft can be coupled at least indirectly, preferably positively, to a motor of a kitchen appliance outside the preparation vessel. It is advantageously provided that a tool is fixedly or releasably connected to the tool holder or the shaft. Alternatively, it is also provided that the tool holder is rotatably magnetically couplable to a motor.

The preparation vessel has, for example, a tool attached to the tool holder for stirring and/or chopping food. Furthermore, it is provided in particular that the preparation vessel has at least one, in particular electrical, heating device with which foodstuffs that can preferably be introduced into the preparation vessel can be heated. The preparation vessel has, for example, at least one electrical interface to the kitchen appliance for the heating device.

The juicing module is designed to cooperate with a preparation vessel, for example in that the juicing module can be placed on a preparation vessel, in particular on an upper edge of the preparation vessel. It is also provided that the juicing module can be inserted at least partially, in particular completely, into the preparation vessel, preferably into the volume provided for food.

The juicing module has at least one drive interface and at least one juicer tool. The drive interface is set up and designed in such a way that it can be coupled at least indirectly to the tool holder and/or the tool of the preparation vessel arranged on the tool holder in order to transmit a torque. Consequently, the drive interface can be coupled at least indirectly to the rotatable tool holder present in the preparation vessel, so that when the tool holder rotates, the drive interface also rotates. It is provided that the drive interface cooperates only with the tool holder or only with the tool or with the tool and the tool holder for transmitting a torque.

The drive interface is connected in a rotationally fixed manner to at least a part of the juicer tool, so that a relative movement between the guide body and the sieve unit can be effected with a rotation of the drive interface. The drive interface has, for example, at least one drive shaft. The drive shaft is preferably couplable or coupled to the guide body or the sieve unit. For example, the drive interface is connected to the juicer tool in such a way that the guide body can be rotated. Alternatively, it is also provided that the drive interface is connected to the juicer tool in such a way that the sieve unit is rotatable.

The drive interface, in particular the drive shaft, and/or the sieve unit and/or the guide body are made, for example, of a plastic or a metal, in particular a stainless steel.

Cleaning is simplified in particular by the fact that the drive interface, in particular the drive shaft, the guide body and/or the sieve unit can be dismantled from one another, in particular without tools. In particular, at least the guide body and/or the sieve unit is mounted in a replaceable manner. It is also provided that the drive interface, in particular the drive shaft, and the guide body are connected to each other in a non-disassemblable manner.

Preferably, the juicing module is intended for use in preparation vessels of kitchen appliances whose motor can be operated at a speed in the range of less than 200 revolutions per minute, in particular less than 150 revolutions per minute. Preferably, the motor of the kitchen appliance is designed to apply a minimum torque of 12 Nm, in particular 15 Nm, more preferably 18 Nm, for example at a speed of less than 200 revolutions per minute, in particular less than 150 revolutions per minute.

Compared to conventional technology, the present disclosure has the advantage that gentle juicing of a wide range of foods is possible. By applying a pressing force between the guide body and the sieve unit, a good juice yield is achieved. The fact that at least some of the components can be dismantled from one another means that less cleaning is required.

According to a first embodiment of the juicing module, it is provided that the guide body is connectable or connected to the drive interface in such a way that a rotation of the drive interface causes a rotation of the guide body, in particular relative to the sieve unit. Preferably, the sieve unit is arranged in a rotationally fixed manner. For example, the drive interface, in particular the drive shaft, can be connected or is connected to the guide body in a form-fitting manner.

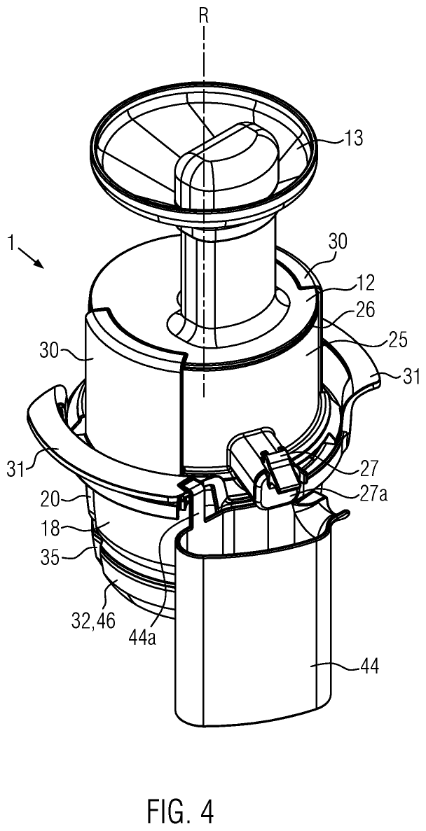

For example, the guide body has a substantially convex outer contour. For example, the diameter of the guide body increases steadily from an upper end in the assembly state to a maximum diameter. For example, the maximum diameter is at about ⅓ of the height of the guide body. In particular, at the maximum diameter of the guide body, the smallest gap width of the gap between the guide body and the sieve unit is formed. Below the maximum diameter, the diameter of the guide body advantageously decreases again in order to be able to advantageously convey out pressed food residues. For example, the conveying body has a teardrop or pear shape. The shape of the conveying body preferably corresponds to the shape of a conveying body disclosed in KR 2006/0101848 A in FIG. 4 or FIG. 7 with the reference sign 20.

It is also provided that the conveying body will be substantially in the form of a cone, cylinder, sphere or ellipsoid.

For example, the guide body has at least one, preferably a plurality of conveying projections on a lower end face in the assembled state in order to convey pressed residues to a pomace opening in the housing of the juicing module.

Preferably, the conveyor body is provided with at least one conveyor contour, in particular on its outer contour. The conveying contour preferably has helically extending webs. The spacing of the webs, starting from an upper end of the guide body in the assembled state, decreases downwards. Consequently, the thread pitch reduces in the direction of the larger diameter of the guide body. As a result, introduced foodstuffs can be conveyed downward through the webs into the gap, in particular the annular gap between the sieve unit and the guide body, and are compressed more strongly and consequently squeezed out as the conveying distance increases. Preferably, the guide body is designed as a pressing screw with one or more of the features described above.

The sieve unit has, at least on the inner circumference, for example a truncated cone shape tapering downwards in the assembled state. Particularly preferably, the sieve unit is arranged in such a way that the diameter of the sieve unit tapers as the diameter of the guide body increases.

It is particularly preferred that the sieve unit has a truncated cone shape at least on the inner circumference, and that the conveying contour has an outer contour such that it has a constant radial distance from the sieve unit. The conveying contour is designed in such a way that the conveying contour complements the basic shape of the conveying body—for example, drop-shaped or pear-shaped—to form a shape with an essentially frustoconical—imaginary—enveloping contour. In this way, the conveying contour has an essentially constant radial distance from the sieve unit when the conveying body is inserted into the sieve unit. At the same time, the distance of the basic shape of the conveying body—e.g. teardrop or pear shape-from the sieve unit varies, in particular in order to realize the tapering gap for the pressing process.

According to a further embodiment of the juicing module, it is provided that the sieve unit comprises at least one first sieve with first sieve openings and at least one second sieve with second sieve openings. The first sieve can be arranged in the second sieve. Advantageously, it is provided that the first sieve and the second sieve are conical. Preferably, the first sieve and the second sieve have a truncated cone shape. This results in an advantageous interaction with a guide body described above for forming a tapering gap for squeezing out food.

For example, the first sieve and the second sieve are designed in such a way that they can be arranged one inside the other in at least two different orientations. An overlap of the first sieve openings and the second sieve openings is different from each other at least in the two different orientations, so that the size of the resulting sieve openings and thus the degree of sieving of the sieve unit can be adjusted, in particular as a function of the food to be squeezed. Preferably, the sieve openings in the first sieve and in the second sieve are formed as substantially horizontally arranged sieve slots. For example, by rotating the first sieve relative to the second sieve, the length of the resulting horizontal sieve slots can then be adjusted. Alternatively or additionally, it is provided that the overlap of the sieve slots can also be adjusted by different penetration depths of the first sieve into the second sieve.

For example, the second sieve has at least one support step in the lower region, preferably a plurality of support steps with different heel heights. In the lower area, the first sieve has support pockets in which the support steps of the second sieve can engage. These defined, different supports allow two different orientations with predefined gap dimensions to be set for the horizontal sieve slots. Advantageously, by rotating the first sieve relative to the second sieve, the pairings of the support pockets and support steps can be changed, whereby the overlap of the sieve slots of the first sieve and the second sieve can be adjusted. In this way, different degrees of sieving can be realized with the sieve unit without the need for additional components.

A further embodiment of the juicing module provides that at least one housing is present. Preferably, at least the sieve unit and the guide body are arranged in the housing. The housing has at least one lid opening, at least one juice outlet and at least one pomace opening, and a lid. The lid is formed such that the lid opening can be closed with the lid. In order to be able to absorb axial forces of the juicer tool in the lid, it is provided in particular that a positive connection can be formed between the lid and the housing in the axial direction of the rotation axis of the juicer tool. It has been found to be advantageous if a bayonet lock is formed between the housing and the lid.

In order to advantageously fix the juicing module, in particular the housing, to or in the preparation vessel or to the kitchen appliance, it is provided that the juicing module is designed for positive cooperation with the preparation vessel and/or the kitchen appliance base, in particular for positive cooperation with the preparation vessel or the kitchen appliance base in the assembled state. For example, the juicing module, in particular the housing and/or a pomace container, has at least one fixing means or a plurality of fixing means for fixing the juicing module to a handle of the preparation vessel and/or a carrying handle of the kitchen appliance base. The fixing means or the fixing means is/are preferably designed to interact positively with a handle of the preparation vessel and/or a carrying handle of the kitchen appliance base, in particular to prevent the juicing module from migrating out of the preparation vessel during operation.

In particular, it is provided that the juicing module, in particular the housing and/or a pomace container, is designed to positively engage behind a contour on the preparation vessel, for example an upper edge of the preparation vessel, advantageously in order to prevent axial migration. Alternatively, it is preferably provided that the juicing module, in particular the housing and/or a pomace container, has fixing means with which the juicing module, in particular the housing and/or a pomace container, can be clamped non-positively against an inner wall of the preparation vessel.

The juice outlet is preferably arranged to extend laterally out of the housing. The juice outlet has, for example, at least one juice flap to close the juice outlet. At least one seal is arranged between the juice outlet and the juice flap, for example. The bottom of the housing preferably has a slope which, in the assembled state on the preparation vessel, directs the juice in the direction of the juice outlet.

At least one pomace opening is arranged at the bottom of the housing, for example, through which pomace residues can be discharged from the housing, in particular into a pomace container arranged below the housing. The pomace opening can be partially or fully closed or partially or fully opened, for example, by means of a pomace opening slide. Between the pomace opening slide and the housing there is preferably a seal to prevent unintentional leakage of juice and pomace from the housing. Preferably, the pomace opening slide is mounted or guided on the pomace container, in particular pivotably or translationally movable.

For example, it is provided that the guide body is supported on the lid for rotation, in particular the guide body is rotatably mounted in the lid, e.g. with a plain bearing. For example, the guide body has a bearing projection which engages in a bearing recess on the lid of the housing.

The lid preferably has at least one filler neck with filler funnel. The filler neck is positioned so that food to be juiced can be filled between the guide body and the sieve unit. By rotating the guide body, food to be juiced is conveyed into the tapering gap between the sieve unit and the guide body and juiced by a pressing force.

In particular, in order to increase the safety of a user during use of the juicing module, according to a further embodiment it is provided that the lid is designed to cooperate with at least two lid holders. Preferably, the lid holders are each arrangeable in a side region of the housing of the juicing module. Preferably, in the assembled state, the lid holders are at least partially supported on an upper side of the lid and on an edge of the pomace container. For example, the lid holders are arrangeable opposite each other on the housing. The lid holders are configured to cooperate with retaining rollers of a kitchen appliance. The retaining rollers typically serve to lock a preparation lid to the preparation vessel. In cooperation with the lid holders, the lid holders provide a defined resistance to the retaining rollers, so that the kitchen appliance can detect by means of the retaining rollers whether the lid holders are mounted.

It is provided that the lid holders can only be mounted on the lid if the lid is correctly mounted, in particular locked to the housing. It is provided that the kitchen appliance e.g. outputs an error message and/or the operation of the juicing module with the kitchen appliance cannot be started if the presence of the lid holders is not detected.

Preferably, the juicing module has at least one pomace container. For example, the pomace container is arranged below the juicer tool, namely below the guide body and the sieve unit. For example, the pomace container is arrangeable below the housing. In particular, the housing can be placed on the pomace container. For example, the pomace container is designed in such a way that it can be inserted at least partially, in particular completely, into the preparation vessel, in particular into the volume of the preparation vessel intended for foodstuffs.

Advantageously, the pomace container has at least two grip pieces which extend outside the preparation vessel in the assembled state. In particular, the grip pieces are arranged opposite each other.

In particular, the pomace container has a shape such that it extends over part of the height of the preparation vessel, preferably about half the height of a preparation interior of the preparation vessel. Preferably, the pomace container circumferentially abuts an interior wall of the preparation vessel over at least a portion of its height. For example, the pomace container has at least one recess that cooperates with at least one protrusion on an inner wall of the preparation vessel to prevent rotation of the pomace container in the preparation vessel by positive engagement. Preferably, the pomace container has a plurality of recesses that cooperate with a plurality of protrusions on the inner wall of the preparation vessel in a form-fitting manner. The pomace container has, for example, a central passage in which the pomace container can be passed through by the drive interface, in particular the drive shaft.

A further embodiment of the juicing module provides that at least one separate juice container is provided. For example, the juice container is mountable to the pomace container, e.g., by hooking the juice container to the pomace container with two hooks. For example, the juice container is hooked or latched to the pomace container or to the housing or is fastened in a force-fit and/or form-fit manner. Preferably, it is provided that the juice container is formed in such a way that, in the assembled state on the pomace container, it is at least partially supported on a handle of the preparation vessel. The juice container can preferably be arranged in such a way that it is located below a juice opening in the housing of the juicing module.

According to a further embodiment, in order to advantageously improve use with kitchen appliances in which the speed of a motor cannot be adjusted or can only be adjusted within narrow limits, it has been found to be advantageous if at least one gear unit is provided. The gear unit has at least one adapter element for at least indirect cooperation with the tool holder of the preparation vessel and at least one output interface. The gear unit is designed to convert a high rotational speed at the adapter element to a lower rotational speed at the output interface. The output interface has, for example, at least one shaft.

The gear unit has, for example, a housing with which it can be at least partially inserted into the preparation vessel. Advantageously, the gear unit can be inserted completely into the preparation vessel, so that it is arranged in the preparation vessel between the tool holder and the pomace container of the juicing module, for example. Preferably, the housing of the gear unit has at least one recess on the outer circumference which can cooperate in a form-fitting manner with projections in the inner wall of the preparation vessel in order to prevent the gear unit from rotating relative to the preparation vessel during operation. Preferably, the housing of the gear unit has a plurality of recesses that can cooperate with a plurality of projections in the inner wall of the preparation vessel.

The adapter element can be connected indirectly or directly to the tool holder of the preparation vessel. If it is provided that the tool in the preparation vessel can be removed, it is preferably provided that the adapter element can be coupled directly to the tool holder, in particular in a form-fitting manner. If it is provided that the tool in the preparation vessel is not removable, it is preferably provided that the adapter element cooperates with the tool in a form-fitting manner so that the rotation can be transmitted from the tool to the adapter element.

The output interface is designed to be positively coupled to the drive interface, in particular for transmitting a torque. For example, an external square is formed for this purpose on the output interface, in particular a shaft of the output interface, and an internal square is formed on the input interface of the juicing module. The gear unit is thus arranged in the chain of rotating components between the tool or tool holder and the juicer tool.

Preferably, it is provided that the coupling point between the drive interface and the output interface of the gear unit is at least partially arranged in the central feedthrough in the pomace container. This ensures a very compact arrangement in the preparation vessel.

Another embodiment of the juicing module provides that the gear unit comprises at least one housing and at least two gears. The gears are arranged in the housing and each coupled to the adapter element and the output interface, respectively. The size ratio of the gears is selected such that a high speed at the adapter element is converted to a lower speed at the output interface.

It has proved advantageous if at least one gearwheel is designed as a sun wheel and at least three gears as planet wheels. In other words, the gearbox advantageously has at least four gears in total. The planet wheels have a larger diameter than the sun wheel. The adapter element preferably has a drive shaft to which the sun wheel is attached in a rotationally fixed manner, so that the sun wheel can be rotated at the rotational speed of the tool holder or the tool of the preparation vessel. The sun wheel is centrally located between and drives the three planet wheels. The planet wheels run in a ring gear. The planet wheels are connected to an upper planet carrier and a lower planet carrier via mandrels. The connection is preferably fixed by retaining rings. The upper planet carrier is coupled to the output interface. The adapter element and the output interface are preferably supported in the housing by plain bearings. Preferably, a rotary shaft seal is provided at the upper end of the output shaft to prevent dripping juice from entering the housing of the gear unit. Preferably, the gear unit is configured to convert a torque of about 2 Nm at about 1100 rpm to about 18 Nm at 122 rpm.

The task mentioned at the beginning is further solved by a kitchen appliance, in particular for preparing food, as described in the embodiment examples. The kitchen appliance has at least one kitchen appliance base with at least one control device, at least one motor, in particular for driving a tool in a preparation vessel, and at least one preparation vessel and at least one juicing module according to one of the described embodiments. The preparation vessel can advantageously be arranged in or on the kitchen appliance base.

According to a first embodiment of the kitchen appliance, it is provided that the kitchen appliance comprises at least two retaining rollers. The retaining rollers are movable between an opening position and a locking position. At least two lid holders can be arranged on the lid of the juicing module in such a way that, in the locked state, each lid holder interacts with a respective one of the retaining rollers. If the retaining rollers are moved from their opening position to their locking position, they automatically come into contact with the respective lid holder, whereby the lid holder forms a resistance for the retaining rollers.

Preferably, the control device of the kitchen appliance is set up and designed in such a way that an error message is output to a user, for example on a display device, if a non-presence of the lid holders is detected with the retaining rollers in the locking position. This occurs in particular if the retaining rollers do not have sufficient mechanical resistance when pivoted into the locking position in the locking position. A display device is, for example, a display on the kitchen appliance or a user's mobile data processing device, for example a smartphone or tablet computer.

A further embodiment of the kitchen appliance provides that the control device is set up and designed to indicate to a user, on the basis of recipe data, setting parameters relating to the juicer tool, in particular relating to the sieve unit and/or the pomace opening, in particular a position of the pomace opening slide. To date, it is not known to perform recipe-controlled juicing of food. It is also envisaged that setting parameters relating to the motor power level to be selected are displayed to the user on the basis of recipe data.

The recipe data is stored, for example, on a data memory that can be read by the kitchen appliance and/or can be obtained or retrieved by the kitchen appliance via a data interface, for example, via a local data connection from a user's mobile terminal, e.g., a smartphone, or retrieved, for example, via the Internet from a server.

For example, setting parameters relating to the sieve unit, such as the orientation of the first sieve relative to the second sieve, are displayed to the user in order to set the degree of sieving. In addition, provision is made to display to the user an opening position of a pomace opening predetermined for the specific foodstuff.

The kitchen appliance can be controlled, for example, with a preparation program for preparing a meal using a defined recipe based on recipe data. The kitchen appliance thereby informs the user about the next steps to be performed for the preparation. In the present case, the user could be prompted to insert the juicing module with a particular juicer tool. If the kitchen appliance recognizes the insertion or if the insertion is confirmed by the user, the motor is driven at a predetermined speed which is determined by the control instructions of the preparation program depending on the recipe.

It is further provided that a pomace opening slide, with which a degree of opening of the pomace opening is adjustable, is provided with an actuator so that the size of the pomace opening can be regulated by the control device on the basis of recipe data.

A further embodiment of the kitchen appliance provides that the control device is arranged and configured to indicate to a user updated setting parameters for the juicer tool, in particular for the sieve unit and/or for a pomace opening, on a display device when a blockage of the rotation of the juicer tool by a food to be juiced is detected, in particular on the basis of monitoring of the motor current. For example, the user is indicated to enlarge the pomace opening or to select larger passage openings at the sieve unit by bringing the first sieve and the second sieve into a different orientation with respect to each other.

Furthermore, according to a further embodiment of the kitchen appliance, it is provided that the control device is set up and designed to operate the motor of the kitchen appliance using recipe data for a juicing process with a predetermined motor power, i.e. at a predetermined motor power level. Recipe data includes, for example, control instructions for the control device to operate the motor or other components with defined parameters.

In particular, the control device is set up and designed to increase the motor power when a blockage of the rotation of the juicer tool is detected, for example by monitoring the motor current. If the control device detects, for example, that the motor current is at a very high level over a longer period of time, which indicates a high resistance/pressure in the juicer tool, it is intended to increase the motor power automatically.

The present disclosure further relates to a preparation vessel for a kitchen appliance, comprising at least one rotatable tool holder and a juicing module at least partially insertable into the preparation vessel according to one of the described embodiments.

In addition, the present disclosure relates to a gear unit for insertion into a preparation vessel having a tool holder. The preparation vessel is preferably a preparation vessel for a kitchen appliance. The gear unit comprises at least one adapter element for at least indirect mechanical cooperation with the tool holder of the preparation vessel. In particular, the gear unit is designed according to one of the described embodiments. In order to advantageously convert a rotation at an adapter element to a rotation at an output interface, the gear unit has at least two gears and is designed to convert a high rotational speed at the adapter element to a lower rotational speed at the output interface. By means of the gear unit, a kitchen appliance or a preparation vessel whose motor delivers a high rotational speed but only a low torque and/or the rotational speed cannot be adjusted or can only be adjusted within narrow limits can be used for applications that require a low rotational speed and a high torque, for example in the range of 15 Nm to 20 Nm. Such applications include the juicing module described above, a pasta press, a meat mincer, etc.

Further advantageous embodiments of the present disclosure are apparent from the following description of figures.

In the various figures in the drawing, the same parts are always given the same reference signs.

Regarding the following description, it is claimed that the invention is not limited to the embodiments and thereby not limited to all or several features of described feature combinations, rather each individual partial feature of the/each embodiment example is also of importance for the subject matter of the invention detached from all other partial features described in connection therewith for itself and also in combination with any features of another embodiment example.

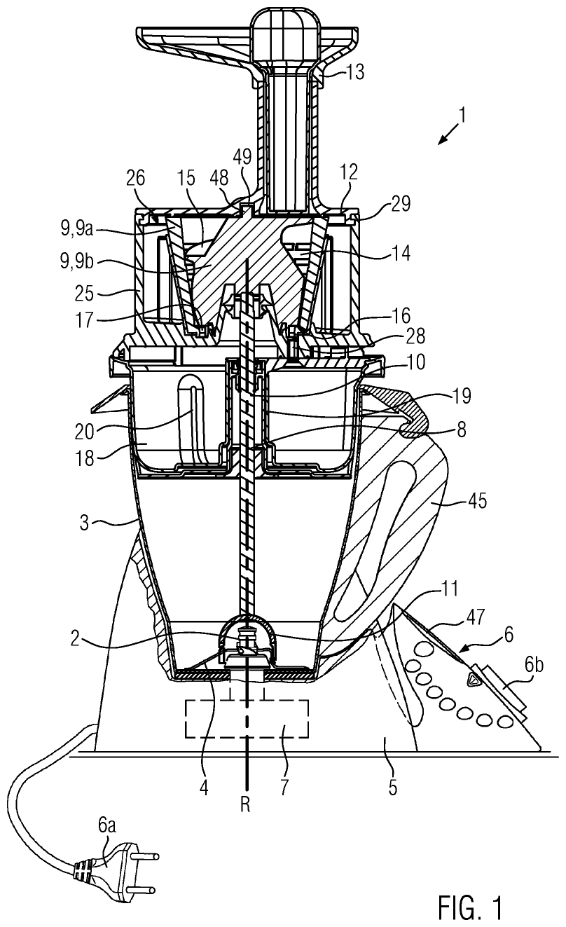

FIG. 1 shows an embodiment example of a juicing module 1 for interacting with a preparation vessel 3, which has at least one rotatable tool holder 2. In this embodiment example, the preparation vessel 3 has a tool 4 in the form of a stirring and cutting knife fixedly mounted to the tool holder 2. The preparation vessel 3 is at least partially insertable into a kitchen appliance base 5 of a kitchen appliance 6. The kitchen appliance 6 has a motor 7 for rotationally driving the tool holder 2 and thus the tool 4 in the state coupled to the kitchen appliance base 5. For power supply, the kitchen appliance 6 has a connector plug 6a. The kitchen appliance 6 can be controlled, for example, by an input means 6b, here in the form of a push and turn knob.

The juicing module 1 has at least one drive interface 8 and at least one juicer tool 9. The juicer tool 9 is connected to the drive interface 8 in such a way that a rotation of the drive interface 8 can cause a rotation of at least a part of the juicer tool 9. In this embodiment example, the drive interface 8 has a drive shaft 10 and a tool adapter 11. The drive shaft 10 of the drive interface 8 is rotatably mounted in the housing 25 and positively connected to the juicer tool 9. The tool adapter 11 is also connected to the drive shaft 10 and interacts positively with the tool 4, so that a rotation of the tool 4 causes a rotation of the juicer tool 9.

The juicer tool 9 has a guide body 9b and at least one sieve unit 9a. If the drive interface 8 is rotated by the tool 4 or the tool holder 2, the guide body 9b rotates about a rotation axis R, while the sieve unit 9a does not rotate. The resulting relative movement between guide body 9b and sieve unit 9a can cause a pressing force on a food product to be juiced. For this purpose, the food is introduced into a gap 14 between sieve unit 9a and guide body 9b through a filling funnel 13 connected to the lid 12. The guide body 9b has an external conveying contour 15 and is designed as a pressing screw. The conveying contour 15 is helical and extends around the guide body 9b in a thread-like manner with a thread pitch that decreases downward.

The cross-section of the sieve unit 9a has the shape of a truncated cone. As a result of the rotation of the guide body 9b, a food product to be juiced is conveyed by the conveying contour 15 into the tapering gap 14 between the guide body 9b and the sieve unit 9a and freed of juice by the pressing pressure acting there.

The guide body 9b has a substantially convex-shaped outer contour, the diameter of which increases from the upper region downward according to the assembly state shown in FIG. 1. The maximum diameter is reached approximately at the level of the lower third of the height. Below the maximum diameter, the diameter of the guide body 9b decreases again in order to be able to convey out press residues. Conveying projections 17 are formed on the lower front face 16 of the guide body 9b for this purpose, with which the press residues can be conveyed into a pomace container 18 arranged below.

The pomace container 18 is at least partially inserted into the preparation vessel 3. The pomace container 18 has a central passage 19 for the drive shaft 10 to pass through. The pomace container 18 also has recesses 20 on its outer circumference, which cooperate with-not shown-projections on an inner wall of the preparation vessel 3 to prevent rotation of the pomace container 18 during operation.

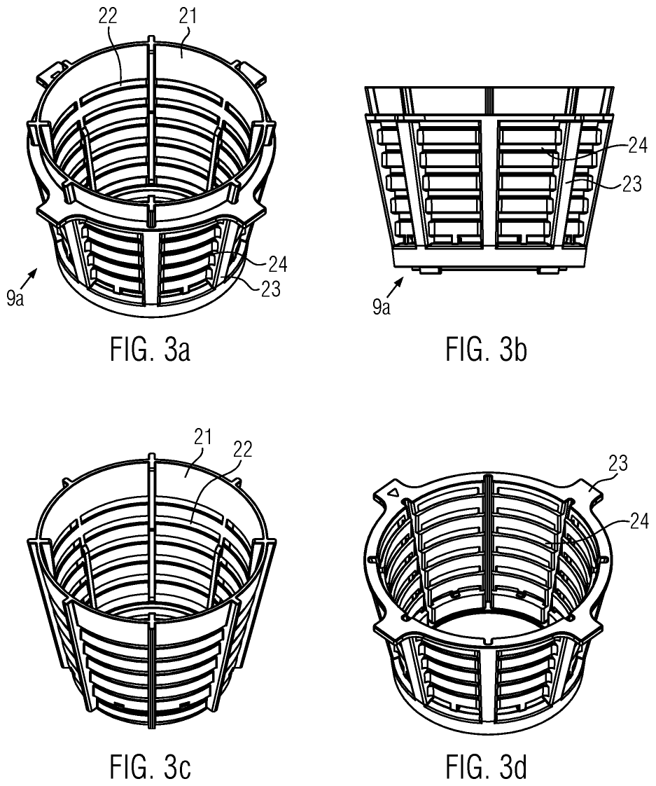

The sieve unit 9a is shown in detail in FIGS. 3a to 3d, for example. According to FIG. 1 and FIGS. 3a to 3d, the sieve unit 9a has a first sieve 21 with first sieve openings 22 and a second sieve 23 with second sieve openings 24. The first sieve 21 and the second sieve 23 are conically shaped in the form of a truncated cone, the diameters of the sieves 21, 23 tapering towards the bottom of the sieve. The first sieve 21 can be arranged in the second sieve 23. The sieve openings 22, 24 are designed in such a way that by a relative movement of the first sieve 21 relative to the second sieve 23—in particular a rotation—the overlap of the first sieve openings 22 and the second sieve openings 24 can be adjusted in at least two orientations relative to one another. The first sieve openings 22 and the second sieve openings 24 are formed as substantially horizontally arranged sieve slots. By changing the alignment of the first sieve 21 with respect to the second sieve 23, the overlap of the first sieve openings 22 and the second sieve openings 24 and thus the size of the resulting sieve passages—the degree of sieving—can be adjusted. Depending on the food to be juiced, the sieve can consequently be set finer or coarser without the need for further components.

FIG. 4 shows another embodiment of a juicing module 1 in a perspective external view. The juicer tool 9 is arranged in a housing 25. The housing 25 has at least one lid opening 26, which can be closed by the lid 12. The housing 25 has, in the lower region, a juice outlet 27 extending laterally from the housing 25. The juice outlet 27 has a juice flap 27a. The juice flap 27a has a seal, which is not shown, and serves to close the juice outlet 27. A pomace opening 28, which is at least partially visible in FIG. 1, is provided on the underside of the housing 25, through which the press residues can be conveyed into the pomace container 18. In order to enable a transmission of force parallel to the rotation axis R between lid 12 and housing 25, a bayonet lock 29 is formed between lid 12 and housing 25.

According to FIG. 4, lid holders 30 are arranged on opposite sides of the housing 25, which can only be mounted when the lid 12 is properly placed on the housing 25 and, in particular, the bayonet catch 29 (see FIG. 1) is locked. In the assembled state, the lid holders 30 rest on an upper side of the lid 12 and at least partially on an edge of the pomace container 18. The lid holders 30 are arranged opposite each other on the housing 25 and extend at least partially parallel to the housing 25 in the height direction. The lid holders 30 are adapted to cooperate with retaining rollers—not shown—of a kitchen appliance 6 to detect, by means of the retaining rollers, a presence of the lid holders 30 and thus a proper closure of the housing 25.

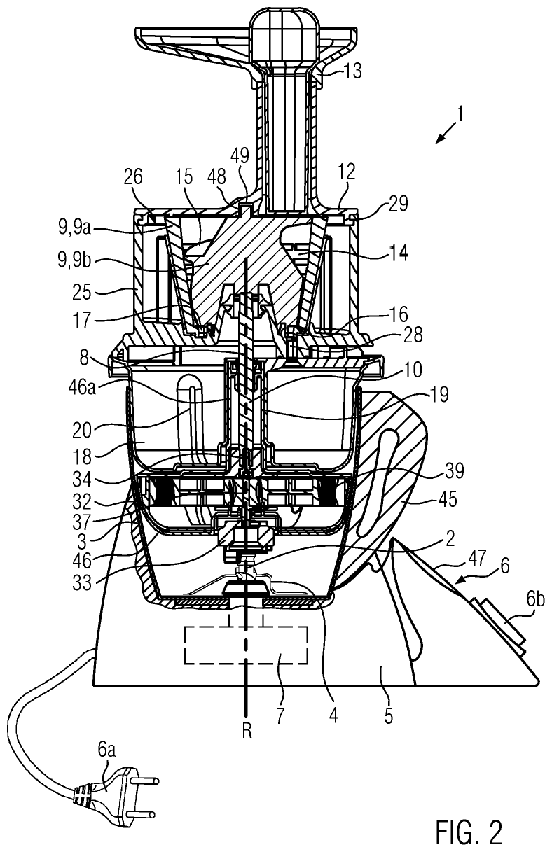

FIG. 2 shows a further embodiment example of a juicing module 1, which is essentially designed according to the embodiment example of FIG. 1. The corresponding components are marked with the same reference signs. For power supply, the kitchen appliance 6 has a connector plug 6a. The kitchen appliance 6 can be controlled, for example, via an input means 6b, here in the form of a push and turn knob.

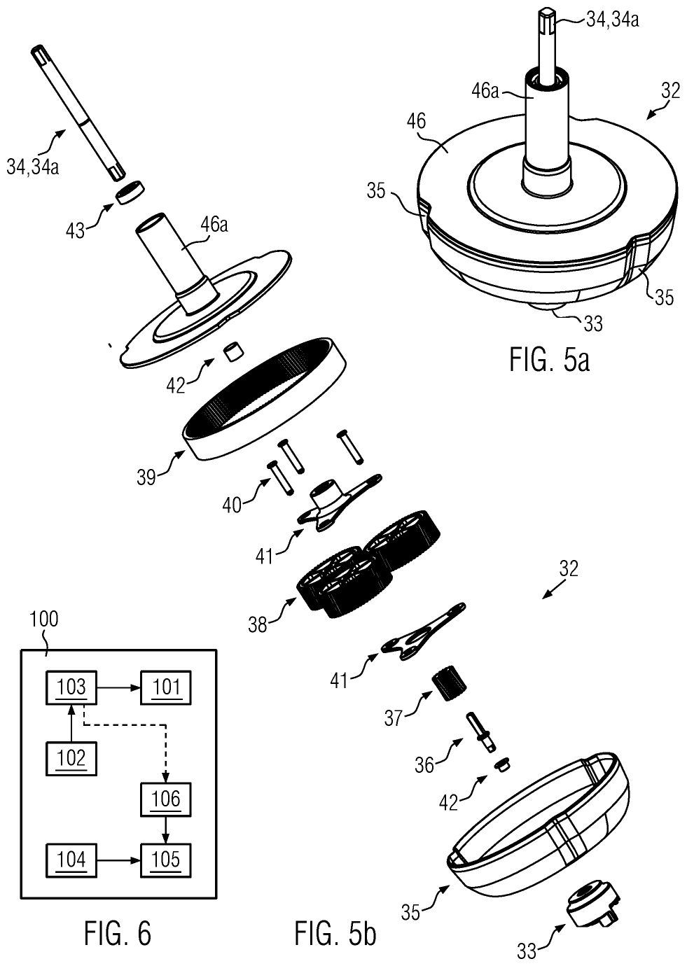

In the embodiment example of FIG. 2, a gear unit 32 is arranged below the pomace container 18 in the preparation vessel 3, which is again shown separately in FIG. 5a and FIG. 5b. The gear unit 32 has at least one adapter element 33 for positive cooperation with the tool holder 2 or the tool 4 of the preparation vessel 3. By means of the adapter element 33, the rotation of the tool holder 2 or the tool 4 is transmitted to the gear unit 32. The gear unit 32 further comprises an output interface 34, which is coupled to the drive interface 8 of the juicing module 1 at the drive shaft 10. For this purpose, the drive interface 8 on the drive shaft 10 has, for example, an inner square and the output interface 34 has an outer square.

The gear unit 32 is designed to convert a high speed at the adapter element 33 to a low speed at the output interface 34. The gear unit 32 can be fully inserted into the preparation vessel 3. To prevent rotation of the gear unit 32 in the preparation vessel 3, the gear unit 32 has recesses 35 in an outer circumference, which interact positively with associated projections—not shown—on the inner surface of the preparation vessel 3. FIG. 5a shows the external square drive at the output interface 34.

A rotation of the tool 4 caused by the motor 7 of the kitchen appliance 6 is transmitted to a first shaft 36 of the adapter element 33. The first shaft 36 is coupled to a gear formed as a sun wheel 37. Consequently, the sun wheel 37 rotates at the same speed as the adapter element 33. The sun wheel 37 is centrally arranged between three gears formed as planet wheels 38, so that the sun wheel 37 is engaged with all three planet wheels 38. The planet wheels 38 are guided in a ring gear 39.

The planet wheels 38 are rotatably mounted in an upper and a lower planet carrier 41 by means of mandrels 40. The connection is secured by circlips 40a. The first shaft 36 and the output interface 34 are mounted in the housing 46 of the gear unit 32 via plain bearings 42. The output interface 34 has a shaft 34a that extends at least partially within a cylindrical projection 46a of the housing 46. The upper planet carrier 41, oriented toward the output interface 34, is connected to and drives the output interface 34. A rotary shaft seal 43 between input interface 34 and housing 46 prevents juice from entering the gear unit 32.

According to FIG. 2, the gear unit 32 enables the guide body 9b to rotate at a significantly lower speed than that at which the adapter element 33 is driven by the tool holder 2 or the tool 4 by means of the motor 7 of the kitchen appliance 6. The juicing module 1 can thus also be used with kitchen appliances 6 whose motor 7 cannot be adjusted with respect to speed, or can only be adjusted within narrow limits.

According to FIG. 4, a juice container 44 can be arranged on the outside of the preparation vessel 3, which is suspended from the pomace container 18 and is supported at least partially on a handle 45 of the preparation vessel 3. The pomace container 18 has two handle pieces 31 arranged opposite one another, which are located outside the preparation vessel 3 in the operating state. The juice container 44 has a retaining arm 44a which can be fastened, in particular suspended, on a handle piece 31 of the pomace container 18. The juice container 44 is thereby arrangeable below the juice outlet 27, in order to let out juice into the juice container 44 by opening the juice flap 27a.

According to FIG. 1 and FIG. 2, the guide body 9b is rotatably mounted between the housing 25 and the lid 12. For mounting in the lid 12, the guide body has a bearing projection 48 and the lid 12 has a bearing recess 49. A plain bearing is formed between bearing projection 48 and bearing recess 49.

FIG. 6 shows a schematic representation of the control sequences of an embodiment of a control unit 100 of a kitchen appliance 6. The control unit 100 of the kitchen appliance 6 is configured and arranged to display 101 updated setting parameters for the juicer tool 9 to a user on a display device 47 when a blockage of the rotation of the juicer tool 9 is detected 103, in particular based on a monitoring 102 of the motor current. The updated setting parameters include information for a user, for example, to adjust the sieve unit 9a and/or a pomace opening 28, for example to increase the resulting sieve passages or to open the pomace opening further.

Referring to FIG. 6, the control device 100 is further arranged and configured to operate 105 the motor 7 at a predetermined motor power using recipe data 104 for a juicing process. The control device 100 is further arranged and configured to increase 106 the motor power of the motor 7 when a blockage of the rotation of the juicer tool 9, for example of the conveying body 9b, is detected 103, in particular based on monitoring 102 of the motor current.

The invention is not limited to the embodiments shown and described, but also includes all embodiments having the same effect in the sense of the invention. It is expressly emphasized that the embodiments are not limited to all features in combination, rather each individual sub-feature may also have inventive significance in isolation from all other sub-features. Furthermore, the invention has not yet been limited to the combination of features defined in any embodiment either, but can also be defined by any other combination of certain features of all the individual features disclosed as a whole. This means that in principle virtually any individual feature of any embodiment can be omitted or replaced by at least one individual feature disclosed elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A juicing module for cooperating with a preparation vessel having at least one rotatable tool holder, comprising at least one drive interface and at least one juicer tool,
wherein the juicer tool can be connected to the drive interface so that a rotation of at least a part of the juicer tool can be effected with a rotation of the drive interface,
wherein the juicer tool has at least one guide body and at least one sieve unit, wherein a relative movement between the guide body and the sieve unit can be effected with a rotation of the drive interface, and wherein the guide body and the sieve unit are designed and arranged in such a manner that with a relative movement between the guide body and the sieve unit a food to be juiced can be conveyed into a tapering gap between the guide body and the sieve unit in order to effect a pressing force on the food to be juiced.

2. The juicing module according to claim 1,
wherein the guide body is connectable to the drive interface in such a way that a rotation of the drive interface causes a rotation of the guide body.

3. The juicing module according to claim 1,
wherein the sieve unit has at least one first sieve with first sieve openings and at least one second sieve with second sieve openings, and wherein the first sieve can be arranged within the second sieve.

4. The juicing module according to claim 1,
wherein at least one housing is present, wherein the housing has at least one lid opening, at least one juice outlet, at least one pomace opening and at least one lid, and wherein the lid opening can be closed by the lid.

5. The juicing module according to claim 4,
wherein two lid holders are present, wherein the lid is configured to cooperate with the lid holders (30), wherein the lid holders are configured in such a way that the lid holders can be mounted on the lid only when the lid is completely locked to the housing.

6. The juicing module according to claim 1,
wherein at least one pomace container is present, wherein the pomace container has at least one recess in its outer circumference for interacting with at least one projection on an inner wall of the preparation vessel.

7. The juicing module according to claim 1,
wherein a juice container is provided, wherein the juice container can be fastened to a pomace container, wherein the juice container is configured in such a way that, in the assembled state, the juice container is supported at least partially on a handle of the preparation vessel.

8. The juicing module according to claim 1,
wherein at least one gear unit is present, wherein the gear unit has at least one adapter element for at least indirect interaction with the tool holder of the preparation vessel and at least one output interface, and wherein the gear unit is configured to convert a high rotational speed at the adapter element to a lower rotational speed at the output interface, wherein the gear unit can be inserted at least partially into the preparation vessel.

9. The juicing module according to claim 8,
wherein the gear unit comprises at least one housing and at least two gear wheels, wherein at least one gear wheel is formed as a sun wheel and at least three gear wheels are formed as planet wheels, wherein the planet wheels have a larger diameter than the sun wheel, and wherein the sun wheel is coupled to the adapter element and the output interface is coupled to the planet wheels.

10. A kitchen appliance comprising at least one kitchen appliance base, at least one control device, at least one motor, at least one preparation vessel and at least one juicing module according to claim 1.

11. The kitchen appliance according to claim 10,
wherein at least two retaining rollers are present, the retaining rollers being movable at least between an open position and a locked position, and wherein at least two lid holders are arranged on a lid of the juicing module in such a manner that, in the locked state, each lid holder interacts with one of the retaining rollers.

12. The kitchen appliance according to claim 10,
wherein the control device is arranged and configured to display to a user, on the basis of recipe data, at least one of setting parameters relating to the juicer tool, and setting information relating to an engine power stage of the engine.

13. The kitchen appliance according to claim 10,
wherein the control device is configured and set up in such a way that updated setting parameters for the juicer tool are displayed to a user on a display device when a blockage of the rotation of the juicer tool is detected, or wherein the control device is configured and set up in such a way that the motor is operated using recipe data for a juicing process with a predetermined motor power.

14. A preparation vessel for a kitchen appliance, with at least one rotatable tool holder and a juicing module according to claim 1, which is at least partially insertable into the preparation vessel.

15. A gear unit for insertion into a preparation vessel with a tool holder, comprising an adapter element for at least indirect mechanical cooperation with the tool holder, at least two gear wheels and at least one output interface, wherein the gear unit is configured to convert a high rotational speed at the adapter element to a lower rotational speed at the output interface.

16. The juicing module according to claim 3, wherein the first sieve and the second sieve can be aligned in at least two different orientations relative to one another, and wherein an overlap of the first sieve openings and of the second sieve openings is different in the two orientations.

17. The juicing module according to claim 4, wherein a form-fit connection can be formed between the lid and the housing in axial direction of a rotation axis of the juicer tool or wherein a bayonet lock is formed between the housing and the lid.

18. The juicing module according to claim 1, wherein at least one fixing means is present, and wherein the fixing means is configured to fix the juicing module to a handle of a preparation vessel, a carrying handle of a kitchen appliance base or a contour of a preparation vessel, or to brace the juicing module against an inner surface of a preparation vessel in a force-fit manner in order to prevent axial drifting.

19. The kitchen appliance according to claim 11, wherein the control device is set up at least for outputting an error message on a display device if a non-presence of the lid holders is detected with the retaining rollers in the locked position.

20. The kitchen appliance according to claim 13, wherein the control device is configured and set up to increase the motor power of the motor if a blockage of the rotation of the juicer tool is detected.
